(19) United States
(12) Patent Application Publication
(10) Pub. No.: US 2023/0021737 A1
(43) Pub. Date: Jan. 26, 2023

(54) CARBON-ENHANCED FUEL CELLS

(71) Applicant: Lyten, Inc., San Jose, CA (US)

(72) Inventors: Michael W. Stowell, Sunnyvale, CA (US); Jacques F. Nicole, Palo Alto, CA (US)

(21) Appl. No.: 17/960,293

(22) Filed: Oct. 5, 2022

Related U.S. Application Data
(63) Continuation-in-part of application No. 17/699,027, filed on Mar. 18, 2022.
Application No. 17/699,027 is a continuation of application No. 16/997,417, filed on Aug. 19, 2020, now Pat. No. 11,462,728.
Application No. 16/997,417 is a continuation of application No. 16/223,785, filed on Dec. 18, 2018, now Pat. No. 10,756,334.
(60) Provisional application No. 63/252,781, filed on Oct. 6, 2021.
(60) Provisional application No. 62/610,018, filed on Dec. 22, 2017.

(51) Int. Cl. H01M 4/1393; H01M 4/04; H01M 4/36; H01M 4/38; H01M 4/62; C01B 32/182

(52) U.S. Cl. CPC H01M 4/1393; C01B 32/182; H01M 4/38; H01M 4/366; H01M 4/0404; H01M 4/0421; H01M 4/625; H01M 2004/021

(57) ABSTRACT

A fuel cell assembly includes multiple fuel cells that are electrically coupled. Each fuel cell includes an electrolyte, an anode, and a cathode that can be fabricated from decorated or non-decorated carbon particles. The carbon particles can be produced by a methane dissociating reactor that converts methane into solid carbon and hydrogen. The electrolyte particles form an electrolyte structure that has a pattern of grooves on the anode and cathode facing surfaces. The electrolyte structure is sintered with microwave energy to fuse the adjacent electrolyte particles at contact points. The anode and cathode layers are deposited on opposite sides of the electrolyte and sintered. The anode and cathode layers are then processed to form multiple electrically fuel cells. The anode layers of the fuel cells are electrically coupled with interconnects to cathode layers of the adjacent fuel cells.

### CROSS-REFERENCE TO RELATED APPLICATIONS

This application claims the benefit of U.S. Provisional Pat. Application No. 63/252,781, “Carbon-Enhanced Fuel Cells” filed on Oct. 6, 2021. This application is a continuation in part (CIP) of US Pat. Application No. 17/699,027 “Carbon Structured Including An Electrically Conductive Material” filed on Mar. 18, 2022, which is a continuation of US Pat. Application No. 16/997,417, “Structured Composite Materials” filed on Aug. 19, 2020 now US Pat. No. 11,462,728, which is a continuation of U.S. Pat. Application Serial No. 16/223,785, “Structured Composite Materials” filed on Dec. 18, 2018 now US Pat. No. 10,756,334, which claims the benefit of U.S. Provisional Pat. Application No. 62/610,018, “Structured Composite Materials” filed on Dec. 22, 2017. US Pat. Application Nos.: 17/699,027, 16/997,417, 16/223,785, 62/610,018, and 63/252,781 are hereby incorporated by reference in their entirety.

### BACKGROUND

Fuel cells are used as a clean energy source that is capable of high energy conversion. Fuel cells discharge clean water with no contaminants such as carbon dioxide gas or nitrogen oxides.

Existing fuel cell fabrication processing is time consuming and requires large amounts of energy. Fuel cells produced using existing fabrication processing output low voltages and high current. Existing fuel cell can require complex electrical systems to increase the output voltages to real world requirements. Existing fuel cell operate at very high temperatures and can also suffer from delamination failures at the interfaces of the anode, cathode, and the electrolyte due to repeated thermal expansion and contraction. What is needed are more efficient fuel cell fabrication processes that produce more durable and efficient fuel cells that inherently output higher voltages at lower currents that are more compatible with real world electrical power systems.

### SUMMARY OF THE INVENTION

A fuel cell assembly can include multiple fuel cells that are electrically coupled. Each fuel cell can include an solid flexible electrolyte, an anode, and a cathode that can be fabricated from decorated or non-decorated carbon particles. The carbon particles can be produced by a methane reactor that converts methane into carbon and hydrogen. The carbon particles can be processed and assembled to form the fuel cell assembly.

Electrolyte particles, that can be a mixture of decorated carbon (graphene) particles and binders, can be pressed into a mold to form an electrolyte structure. When compressed, the binder can temporarily hold the decorated carbon (graphene) particles together. The electrolyte structure can then be exposed to microwave energy which can drive out the binder materials. The electrolyte particles are then further heated with microwave energy to partially melt the outer surfaces of the electrolyte particles so that the electrolyte is sintered with the adjacent electrolyte particles fused together at their contact points. Microwave energy can also be used to anneal the solid flexible electrolyte electrolyte.

An anode layer can be deposited onto an anode facing surface of the solid flexible electrolyte electrolyte and a cathode layer can be deposited onto a cathode facing surface of the electrolyte. The anode layer can be created from anode particles that can be carbon particles decorated with conductive anode materials. The cathode layer can be created from cathode particles that can be carbon particles are decorated with conductive cathode materials. The anode and cathode layers can be deposited onto their respective surfaces of the electrolyte with binders through a spray deposition process or any other suitable deposition process. The binders can hold the anode and cathode particles to the solid flexible electrolyte electrolyte. The anode, cathode, and electrolyte assembly can be exposed to microwaves to drive out the binder materials and sinter the anode and cathode layers. The microwave energy can heat the decoration materials to a higher temperature than the carbon particles so that the anode layer can be sintered and the anode particles can be fused to adjacent particles at the contact points of the decorative conductive anode materials. Simultaneously, the cathode layer can be sintered with the microwave energy and the cathode particles can be fused to adjacent cathode particles at the contact points of the decorative conductive cathode materials. An anode electrode layer can be deposited onto the anode layer and a cathode electrode can be deposited onto the cathode layer in the same described microwave sintering process. Microwave energy can also be used to anneal the anode and cathode layers.

The anode and cathode layers of the fuel cell can be etched to form multiple fuel cells on the same solid flexible electrolyte structure. More specifically, the anode and cathode layers can be etched to create multiple adjacent anodes and cathodes. Each pair of anodes and cathodes on opposite sides of the electrolyte can form a separate fuel cell.

Each fuel cell can have a low voltage output. However, by electrically coupling each of the fuel cells in series, the voltage output of each fuel cell is added and the cumulative voltage output of the fuel cell assembly can be high enough to be useful for many electrical applications. More specifically, the anode electrode of a first fuel cell can be electrically coupled with an interconnect to the cathode electrode of an adjacent fuel cell. The fuel cell interconnects can extend through the solid flexible electrolyte or extend around the side of the electrolyte. If the fuel cell assembly has 10 fuel cells and each fuel cell emits a 1 volt output, the voltage output of the fuel cell assembly will be 10 volts.

In some embodiments, the anode, cathode, and solid flexible electrolyte can be formed with structured composite materials (SCMs) that can include carbon particles and a decoration material active material that is deposited on the exposed surfaces and within the pores of the carbon particles. The carbon particles can include: carbon nan-onions, carbon allotropes, graphene, and other carbon containing matter such as aluminum or copper intermixed with carbon. The decoration materials can be electrically conductive materials (ECM) such as: sulfur, sulfur compounds, silicon, silicon compounds, boron, bromine, platinum, nickel, silver, molybdenum, iron, and other suitable materials.

In some embodiments, the 3-phase reaction area of the fuel cell can be increased by forming a pattern of grooves on the interface between the solid flexible electrolyte and the cathode. By creating a pattern of grooves having peaks and valleys that can be smooth curved surfaces and/or sharper groove bends. By forming the pattern of grooves, the surface area can be increased by approximately 50% or more compared to a planar area interface between the electrolyte and the cathode. The increased surface area can allow the fuel cell to convert more oxygen into oxygen ions resulting in a doubling of the power density and higher overall fuel cell energy production efficiency. More specifically, the higher 3-phase reaction area can allow the fuel cell to process oxygen (O₂) gas at a higher flow rate into oxygen ions (2O²⁻) that pass through the solid flexible electrolyte and combine with the hydrogen (H) to form water (H₂O) and electrical energy.

### BRIEF DESCRIPTIONS OF THE DRAWINGS

FIG. 1 illustrates a side view of a fuel cell.

FIG. 2 illustrates a side view of a multiple fuel cell assembly, according to some embodiments.

FIG. 3 illustrates a side view of a multiple fuel cell assembly, according to some embodiments.

FIG. 4 illustrates a side view of a fuel cell having a 3-phase reaction area that has a pattern of grooves, according to some embodiments.

FIG. 5 illustrates a side view of a fuel cell having a planar 3-phase reaction area, according to some embodiments.

FIG. 6 illustrates a side view of a fuel cell having an anode, electrolyte, and cathode formed from sintered carbon particles, according to some embodiments.

FIG. 7 illustrates a side view of a fuel cell, according to some embodiments.

FIG. 8A illustrates a perspective view of a tubular fuel cell assembly, according to some embodiments.

FIG. 8B illustrates a cross section of a tubular fuel cell assembly, according to some embodiments.

FIG. 8C illustrates a front view of a multiple parallel tubular fuel cell assembly, according to some embodiments.

FIG. 9 illustrates an enlarged view of decorated carbon particles, according to some embodiments.

FIG. 10 illustrates a process for sintering decorated carbon particles, according to some embodiments.

FIG. 11 illustrates a flow chart for fabricating a fuel cell, according to some embodiments.

FIG. 12 illustrates a photograph of a cross section of a fuel cell, according to some embodiments.

### DETAILED DESCRIPTION

Fuel cells including solid oxide fuel cells (SOFCs) have great potential for providing efficient power generation for industrial, residential, transportation, and military applications. SOFCs convert the fuel’s chemical energy directly into electrical energy. The simplicity of SOFC systems provides the potential for high efficiency power generation.

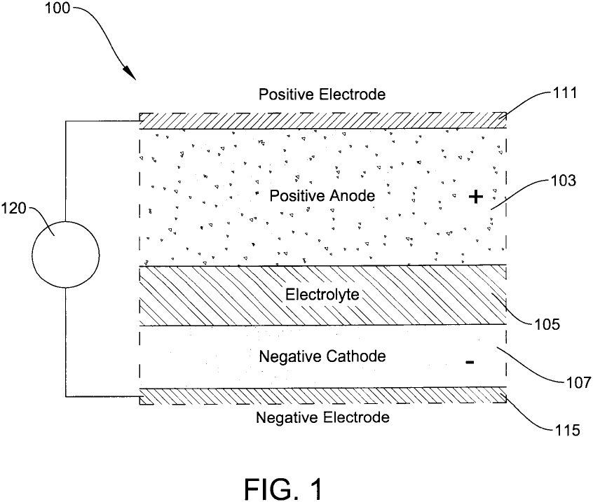

With reference to FIG. 1, the fuel cell 100 has a structure that has a solid flexible electrolyte 105 that is sandwiched between an anode 103 and a cathode 107. Hydrogen H₂ gas is passed through the anode 103 and is split into individual hydrogen H ions and electrons by a catalyst. Oxygen gas O₂ is passed through the cathode 107 that absorbs electrons and creates oxygen ions O²⁻. In solid oxide fuel cells (SOFCs), the oxygen ions O²⁻ pass through the solid flexible electrolyte 105 and combine with the hydrogen H₂ gas to form water H₂O that is expelled from the fuel cell. The electrons pass from the anode 103 to a positive electrode 111 that is coupled to an outer surface of the anode. The electrons flow through an electrical circuit 120 to a negative electrode 115 that is coupled to the cathode 107 that absorbs the electrons.

In the present disclosure, fuel cell components and assemblies made from structured composite materials (SCMs) are described. In different embodiments, the SCMs can contain different combinations of carbon particles that are decorated with conductive particles, electrically conductive materials (ECMs), and/or active materials. In some embodiments, the porous carbon particles provides a structural framework (or scaffold) and the ECM provides high electrical conductivity to the SCM. In some cases, the ECM is decorated on the surfaces and/or in the pores of the carbon particles. The ECMs can form a continuous (or semi-continuous, with some disconnected regions and/or islands) matrix and/or a coating throughout the SCM. In some cases, the porous carbon particles and the conductive particles are coalesced (or, welded together) by decorating an ECM on the carbon particles. The resulting SCMs can contain porous media and conductive particles embedded in a matrix of the ECM. In some cases, the active material is decorated on the surfaces and/or in the pores of the ECM and provides activity (e.g., energy storage capacity) to the SCM.

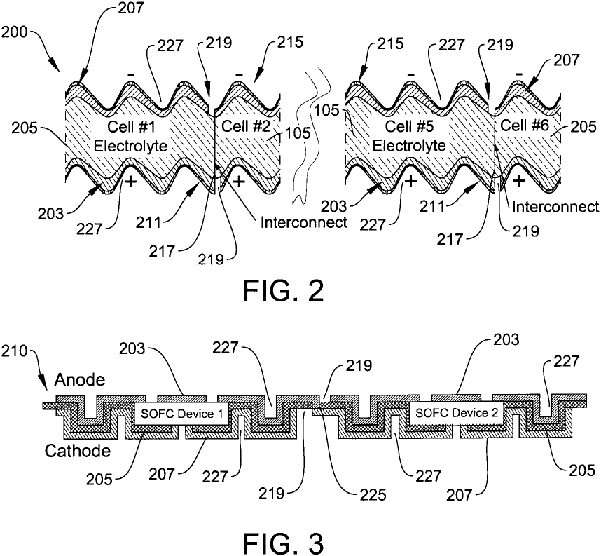

FIG. 2 illustrates an embodiment of a fuel cell structure 200 that has multiple electrically coupled fuel cells by interconnects 217. In the illustrated embodiment, the fuel cells each have a solid flexible electrolyte 205 that has grooved surfaces that are non-planar on opposite surfaces of the electrolyte 205. In the illustrated embodiment, the grooved surfaces on opposite sides of the electrolyte 205 have smooth rounded peaks and valleys that can be configured so that the vertical thickness of the solid flexible electrolyte 205 can be uniform in thickness. A thin anode layer 203 is coupled to a first grooved surface of the electrolyte 205 and a thin cathode layer 207 is coupled to the second opposite grooved surface of the electrolyte 205. A thin anode electrode 211 is coupled to an outer surface of the anode layer 203 and a thin cathode electrode 215 is coupled to an outer surface of the cathode layer 207. The thin anode layer 203, thin anode electrode 211, thin cathode layer 207, and thin cathode electrode 215 can all be uniform in thickness and conform to the grooved surface of the electrolyte 205. The exposed outer surfaces of the thin anode electrode 211 and the thin cathode electrode 215 can also have a grooved surface.

In the illustrated embodiment, the grooved surface configuration of the fuel cell structure 200 can be formed through a process that can include pressing a powdered electrolyte particle material in a mold to form the electrolyte 205. The mold for the press can have grooved surfaces so that the electrolyte 205 is pressed into a solid structure having a grooved anode facing surface and a grooved cathode facing surface. The pressed electrolyte structure can be removed from the press mold and sintered so that the contact points of the adjacent powdered particle material are fused together to create a strong rigid electrolyte structure. The sintering processing can be done with microwave energy applied to the electrolyte 205 which will heat the outer surfaces of the powdered electrolyte particle material partially melt and fuse together at their contact points while the centers of the powdered electrolyte particle material remains cooler and solid. Alternatively, the sintering or any other sintering method such as placing the electrolyte 205 into a sintering furnace. The end result is a solid flexible electrolyte structure.

After the electrolyte 205 has been sintered, an anode material can be spray deposited onto an anode facing side of the electrolyte 205 and a cathode material can be spray deposited onto a cathode facing side of the electrolyte 205. The anode material and the cathode material can be decorated carbon particles such as graphite or graphene that are decorated with different metal materials. The anode layer 203 can be created by spray depositing anode particles onto an anode facing surface of the electrolyte 205 and the cathode layer 207 can be created by spray depositing cathode particles onto a cathode facing surface of the electrolyte 205. Anode electrode materials can be spray deposited onto the exposed surface of the anode layer 203 to form the anode electrode 211 and cathode electrode materials can be spray deposited onto the exposed surface of the cathode layer 207 to form the cathode electrode 215. The spray deposition process can include heating the decorated carbon particles to a molten state and then spraying these semi-solid molten particles with a gas jet towards the solid flexible electrolyte 205. The semi-solid molten particles are sprayed onto the electrolyte 205 and adhere to the electrolyte 205 to form the anode layer 203 and the cathode layer 207 on opposite sides of the electrolyte 205. The anode electrode 215 can then be spray deposited on the anode layer 203 and the cathode electrode 211 can be spray deposited on the cathode layer 207.

This fuel cell structure 200 can then be sintered to fuse the adjacent decorated particles in the anode electrode 215, the anode layer 203, the cathode electrode 211, and the cathode layer 207. The sintering of the adjacent decorated particles can be performed with microwave processing or other sintering methods such as sintering furnaces. The finished fuel cell structure 200 can have grooves 227 in the exposed anode electrodes 215 and the cathode electrodes 211.

The illustrated fuel cell structure 200 has six distinct and separate fuel cells that are electrically coupled in series. Each fuel cell can have a voltage output Vₙ and the voltage output of the fuel cell structure 200 can be cumulative, where the total fuel cell assembly voltage output = Vₒᵤₜₚᵤₜ = V₁ + V₂ + V₃ + V₄ + V₅ + V₆. The series configuration can be important because the voltage output of each cell can be very low. For example, the voltage output for each fuel cell can be between about 0.2 - 2.0 volts. Most electrical equipment does not operate at such a low voltage and therefore a higher voltage source can be necessary for providing electrical power to electrical equipment. By configuring the fuel cells in series, the voltages for each fuel cell are added. For example, if V₁, V₂, V₃, V₄, V₅, and V₆ each = 2 volts direct current (DC) and are coupled in series, then the fuel cell assembly output voltage, the Vₒᵤₜₚᵤₜ would be 12 volts which is a much more common and useful voltage power supply. Power in Watts (P) = Volts (V) x Amps (A). Therefore, if the power output of each fuel cell is 1 kW with an output voltage of 2 V, the current produced by each fuel cell is 500 A. Because the fuel cells are coupled in series, the current produced by the fuel cell structure 200 will be 500 A. In other embodiments, the fuel cell structure 200 can have any number of fuel cells that can be electrically coupled in series and/or in parallel.

The thin anode layer 203 and thin anode electrode 211 can cover the anode facing surface of the solid flexible electrolyte 205. The thin cathode layer 207, and thin cathode electrode 215 can cover the cathode facing surface of the electrolyte 205. However, each fuel cell has a separate anode, anode electrode, cathode, and cathode electrode. An isolation 219 is placed between the adjacent thin anode layers 203, thin anode electrodes 211, thin cathode layers 207, and thin cathode electrodes 215 of the adjacent fuel cells. The isolation 219 are non-conductive and can be an open gap or an insulative non-conductive material between the adjacent thin anode layers 203, thin anode electrodes 211, thin cathode layers 207, and thin cathode electrodes 215.

In the illustrated embodiment, the adjacent fuel cells are electrically coupled to each other in a sequential manner by interconnect conductors 217 that extend through the thickness of the solid flexible electrolytes 205. The interconnect conductors 217 electrically connect the anode electrode 211 of a fuel cell to the cathode electrode 215 of an adjacent fuel cell. The interconnect conductors 217 can be formed by etching holes through the thickness of the solid flexible electrolytes 205 and then depositing or inserting a conductive material in the etched holes to electrically couple the anode electrodes 211 to the cathode electrodes 215.

In the illustrated embodiment, the interconnect conductors 217 connect the anode electrode 211 of a fuel cell #1 to the cathode electrode 215 of adjacent fuel cell #2. The center fuel cells #3 and #4 of the fuel cell structure 200 is not illustrated. The interconnect conductors 217 between the anode electrode 211 of fuel cell #5 and the cathode electrode 215 of a fuel cell #6 are illustrated. While the illustrated configuration shows the interconnect conductors 217 passing through a portion of the electrolyte 205, in other embodiments, the interconnect conductors 217 can be electrical conductors that extend around a side of the electrolyte 205 to electrically couple the anode electrode to the cathode electrode of an adjacent fuel cell.

FIG. 3 illustrates another embodiment of a fuel cell assembly 210 that has more rectangular cross section grooves 227 than the rounded cross section grooves 227 in the fuel cell assembly illustrated in FIG. 2. The rectangular grooves 227 can provide more surface area than rounded cross section grooves and therefore rectangular cross section grooves 227 can be more efficient than rounded cross section grooves. However, a fuel cell assembly 210 with rectangular grooves 227 may require special design considerations. It can be very difficult to remove pressed electrolyte structures from electrolyte molds having sharp corners and thin protruding features. A basic consideration in designing an electrolyte mold with rectangular grooves 227 is to avoid sharp corners in the mold groove design. Other limitations of molded fuel cell components can be a maximum surface area below 20 square inches (0.013 m²) and a height-to-diameter ratio of the grooves that is below 7-to-1. The walls that form the grooves in the fuel cell components may also need to be thicker than 0.08 inches (2.0 mm). The adjacent wall thickness ratios may be below 2.5-to-1. By following these mold design guidelines, fuel cell components with rectangular grooves 227 can be fabricated through molding processing.

In some embodiments, the fuel cell assembly 210 can be fabricated with a process that can include fabricating fuel cell such as the solid flexible electrolyte with planar surfaces and then etching or machining the planar surfaces to create the grooved surfaces and the isolations between the adjacent anodes 203 and cathodes 207, and holes for the interconnects between the anodes 203 and cathodes 207 of the adjacent fuel cells. A conductive material can then be deposited in the holes to form the interconnects between the anodes 203 and cathodes 207 of the adjacent fuel cells. In alternative embodiments, the grooved surfaces on the fuel cell components can be formed with a process that can include patterned material deposition on planar surfaces of the fuel cell components to create the grooved surfaces.

In an embodiment, the solid flexible electrolyte 205 can be made of electrolyte particles that are pressed into a three dimensional structure having two opposite surfaces that will become the anode facing surface and the cathode facing surface. The planar surfaces of the electrolyte 205 can then be etched or machined to form grooves with vertical sidewalls. The electrolyte 205 can also be etched, machined, or drilled through the entire thickness of the electrolyte 205 at the borders 225 of the adjacent fuel cells to form interconnect conductor holes. Various methods can be used to remove material from the electrolyte including: laser etching, electro-etching, electrochemical etching, micro-machining, drilling, etc.

The electrolyte 205 can be sintered to fuse the electrolyte particles at their contact points and form a high strength solid flexible electrolyte 205 structure. In some embodiments, the anode layer 203 can be spray deposited onto the grooved anode facing surface of the electrolyte 205 and the cathode layer 207 can be spray deposited onto the grooved cathode facing surface of the electrolyte 205. In the illustrated embodiment, the anode layer 203 material can fill the etched portions of the electrolyte 205 at the borders 225 of the adjacent fuel cells. Once the anode layer 203 and the cathode layer 207 are deposited on the electrolyte 205, these surfaces can be etched to create gaps 219. The anodes 203 of the adjacent fuel cells are separated by isolations 219 that can be non-conductive and can be open gaps or insulative materials in the open gaps and the cathodes 207 of the adjacent fuel cells are also separated by non-conductive isolations 219. The anode layer 203 and the cathode layer 207 can also be etched to form the grooves 227 that have vertical side walls.

In this embodiment, the anode electrodes can be integrated into the anode 203 structures and the cathode electrodes can be integrated into the cathode 207 structures. The anode layer 203 can be electrically connected to the cathode layer 207 at the borders 225 of the adjacent fuel cells so that the adjacent fuel cells are electrically connected in series. The right end of the anode 203 of the first fuel cell is electrically coupled to the left end of the cathode 207. In some embodiments, solid flexible electrolytes 205 can be etched through the entire thickness at the borders 225 before the anode layer 203 or the cathode layer 207 are deposited so that an electrical connection between the anode layer 203 and the cathode layer 207 can be formed when these layers are deposited. In the illustrated embodiment, the right edge of the anode 203 of the left fuel cell separates the solid flexible electrolytes 205 of the two adjacent fuel cells. In other embodiments, the anode layer 203 can be coupled to the cathode layer 207 with an electrical interconnect that extends around the side of the fuel cell 210.

The illustrated fuel cell assembly 210 includes two fuel cells that each include: a solid flexible electrolyte 205, an anode 203 and a cathode 207. If the power output of each fuel cell is 500 W with an output voltage of 3 V, then the total voltage output would be 6 V and the current output would be 250 A.

As discussed above, the anode layer, anode electrode layer, cathode layer, and cathode electrode layer can be spray deposited. “Thick-film” technologies, that do not require a vacuum for deposition, can be used for the spray deposition to deposit the anodes, anode electrodes, cathodes, and cathode electrodes in one or more deposited layers. Each deposited thick film layer can be between about 0.0001 to 0.1 mm in thickness. A benefit to patterning these thick film materials with etch processing is the ability to create multiple cells on one substrate. A large anode layer can be deposited on an anode facing side of the electrolyte and a large cathode layer can be deposited on a cathode facing side of the electrolyte. In order to form multiple fuel cells, portions of the anode and cathode layers can be removed to create separate and distinct anode and cathode layers for each fuel cell formed on the common solid flexible electrolyte substrate. The process for removing portions of the anode and cathode layers can include: laser etch, chemical etch, micromachining, or any other suitable processing.

By coupling the multiple fuel cells in series, the low voltage output of each of the individual fuel cells can be combined to a higher more useful voltage such as five or more volts. Because the fuel cells are on the same substrate, the multiple fuel cells can occupy the same physical footprint as a prior art single fuel cell that would have a much lower voltage output. This more compact multiple fuel cell assembly structure can ease the integration of the inventive fuel cell assembly into real world devices, at a greatly reduced cost. This inventive multiple fuel cell assembly has the potential to save as much as 75% of the energy and time to fabricate compared to known fuel cell fabrication processes. The inventive multiple fuel cell assembly can also greatly reduce the overall carbon footprint because methane can be processed in a reactor to create hydrogen fuel (used for fuel in the fuel cell) and solid carbon particles (used in the manufacture of the solid flexible electrolyte). In some embodiments, the plurality of carbon particles are produced in a first region of a reactor, and the depositing or decorating of the carbon particles with an electrically conductive material occurs in a second region of the reactor. The first and the second regions of the reactor can be arranged such that the porous carbon particle media exits the first region of the reactor and enters the second region of the reactor without being exposed to an environment containing more than 100 ppm of oxygen. The hydrogen produced by the reactor can be used to power the inventive fuel cells. The only emission from the fuel cells is water so there is only consumption of carbon rather than emission of carbon. This innovation enables the low-cost, high-volume fuel cell production needed for market adoption of fuel cell technology.

One of the factors that influence the efficiency and output of a fuel cell is the 3 phase reaction boundary layer which is the interface area between the cathode layer 207 and the solid flexible electrolyte 205. For fuel cells, the 3 phases are: an ion conductor electrolyte, an electron conductor, and a virtual “porosity” phase for transporting gaseous fuel molecules. The electrochemical reactions that fuel cells use to produce electricity occur in the presence of the 3 phases at the 3 phase reaction boundary layer. The oxygen reduction reaction that occurs at the 3 phase reaction boundary layer which is the cathode and electrolyte interface, can be written as Table 1:

Table 1

| | |
|---|---|
| Reaction | Equation |
| Anode reaction | 2H₂ (gas) + 20²⁻ (gas) → 2H₂O (gas) + 4e⁻ |
| Cathode reaction | O₂ (gas) + 4e⁻ → 20²⁻(gas) |
| Overall cell reaction | 2H₂ (gas) + O₂ → 2H₂O (gas) |

Increasing the 3 phase reaction boundary layer surface area will increase the electro-chemical reaction rate, and thus increase cell performance. The 3 phase reaction boundary power output density will also be influenced by the kinetics of the oxidation reaction that occurs between oxygen ions and fuel on the anode layer of the fuel cell. The efficiency and output of a fuel cell can be proportional to the 3 phase boundary layer area so that a fuel cell with a larger 3 phase boundary layer area will be more efficient and have a higher electrical output than a fuel cell with a smaller 3 phase boundary layer area. One way to increase the area is to have a 3 phase boundary layer area that is a non-planar grooved surface rather than a flat planar area.

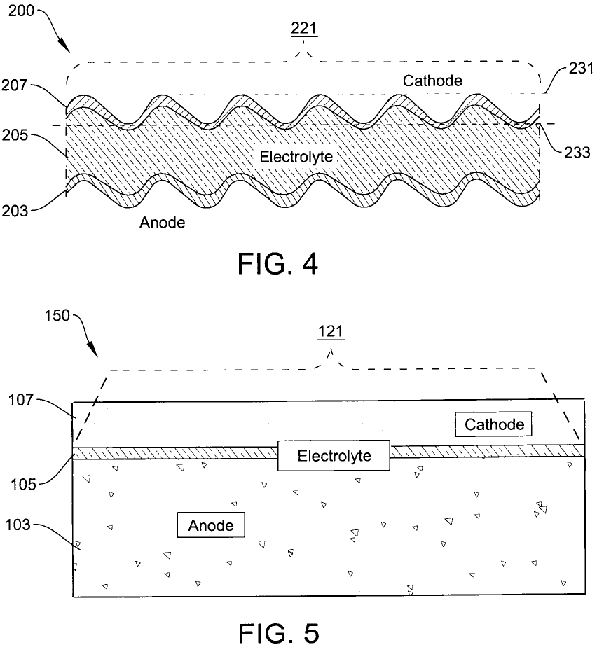

An embodiment of a fuel cell structure 200 having a grooved 3 phase reaction boundary layer surface is illustrated in FIG. 4 and an embodiment of a fuel cell assembly 150 having a planar 3 phase reaction boundary layer surface is illustrated in FIG. 5. With reference to FIG. 4, because the grooved 3 phase reaction boundary area 221 is substantially larger than planar 3 phase reaction boundary area, a fuel cell 200 having a grooved 3 phase reaction boundary area 221 will have a higher power output than a fuel cell assembly 150 that has planar 3 phase reaction boundary area. In the illustrated embodiment, the grooves 227 can have peaks 231 and valleys 233 that are uniform so that each of the grooves 227 has a uniform depth.

The increase in 3 phase reaction boundary area 221 can be proportional to the depth from the peaks 231 to the valleys 233 and the distance between the peaks 231. In the illustrated embodiment, the depth of the valleys 233 is approximately 50% of the distance between the adjacent valleys 233. The angles formed by the peaks and valleys can be approximately 90 degrees with each surface of the grooved 3 phase reaction boundary area 221 being approximately 45 degrees. The grooved 3 phase reaction boundary area 221 can be formed by pressing the electrolyte particles in an electrolyte mold that has patterned groove surfaces. The surface area between each of the adjacent peaks 231 can be roughly calculated as (distance between peaks)/(cosine valley angles). For example, if the distance between peaks is 1 millimeter and the angle of the valleys is 45 degrees, the distance between the adjacent peaks across the valley is 1 millimeter /(cosine 45 degrees) = 1.41 millimeters representing a 41% increase in surface area of the 3 phase reaction boundary area 221. Steeper valley angles can result in deeper grooves and higher increases in the 3 phase reaction boundary area 221.

As discussed above with reference to FIG. 3, in other embodiments, the 3 phase reaction boundary area can have a pattern of rectangular grooves that can be formed through a chemical etching, laser etching, micromachining, or other suitable process. The surface area of these rectangular grooves can be roughly calculated by adding the surface areas of side walls of the grooves. The surface area of the grooved surface can be (the distance between the adjacent peaks) + 2 (the depth of grooves). If the depth of the grooves is 50% of the distance between the adjacent peaks, then surface area is effectively doubled. For example, if the distance between the adjacent peaks is 10 millimeters and the depth of the grooves is 5 millimeters, then the total surface area of each rectangular groove is 20 millimeters. Deeper grooves will result in higher 3 phase reaction boundary areas.

Micromachining is a manufacturing technology that involves the use of mechanical micro tools with geometrically defined cutting, edges in the subtractive fabrication of devices or features with at least some of their dimensions in the micrometer range. Micromachining techniques include bulk micromachining that includes selective etching, surface micromachining that builds a surface layer deposited on a surface. Micromachining can used to form the surface grooves and intorconnoctions on the fuel cell assembly.

Patterning the solid flexible electrolyte material increases the active surface area of the triple phase boundary density per fuel cell and can also reduce the overall thickness of the electrolyte. The patterned grooved features on anode facing surface and cathode facing surface of the electrolyte can be formed in various different ways. In an embodiment, the electrolyte particles can be compressed in a mold having the desired patterned grooved surfaces. In another embodiment, the anode facing and cathode facing surfaces of the electrolyte can be exposed to a micro-abrasion media that can create the patterned grooved features. In yet another embodiment, the anode facing and cathode facing surfaces of the electrolyte can be exposed to laser patterning that can cut the patterned grooved features.

### Thermal Expansion

A common failure mode for fuel cells is delamination at the component layer interfaces, i.e., the interface area of the anode to the solid flexible electrolyte and the interface area of the cathode to the solid flexible electrolyte. Each component layer can be made of a different material that can each have a different coefficient of thermal expansion (CTE), so each component expands at a different rate when heated. The patterned grooved features formed on the electrolyte, anode, anode electrode, cathode, and cathode electrode described above, can also mitigate delamination failures due to the different material layers of the fuel cell having different coefficients of thermal expansion.

When operating, fuel cell temperatures rise to 400° C.-1,000° C., causing the anode, cathode, and solid flexible electrolyte all to expand. The difference in expansion rates creates stress between the anode and the electrolyte and between the cathode and the electrolyte, eventually causing delamination. When operating, the fuel cell temperatures can rise from ambient to 400° C.-1,000° C. and the different layers will expand according to the thermal expansion equation, ΔL = α L ΔT, where ΔL is the change in length L due to thermal expansion, α is the coefficient of linear thermal expansion, and ΔT is the change in temperature. If each of the different solid flexible electrolyte, anode, anode electrode, cathode, and cathode electrode layers of the fuel cell have the same α coefficient of linear thermal expansion, then each layer will expand the same amount for any change in temperature and there will not be any strain between the adjacent layers of the fuel cell.

In an embodiment, the α coefficients of thermal expansion are relatively close in value so that the strain between the adjacent layers of the fuel cell will be well below the bonding strengths of the adjacent layers. For example, the α coefficient of thermal expansion of the anode layer or the cathode layer can be within 5% of the α coefficient of thermal expansion of the solid flexible electrolyte.

Another way to avoid delamination is have flexible anode and cathode layers. The flexibility of the fuel cell assembly layers can depend on layer thickness. Generally, a thicker layer will result in a less flexible layer. Thinner layers can be flexible while also being tough and hard and suitable for the mechanical and thermal requirements of fuel cells The deposited sintered layers of the fuel cell can be structures with a flexibility sufficient to permit a high degree of bending without breakage under an applied force and a high degree of thermal expansion without delamination.

Thus, a way to reduce the rigidity of the fuel cell components can be to reduce the thicknesses of the anode and cathode layers. By using thinner anode and cathode layers, these layers will be more flexible and can absorb the strain at the interfaces with the solid flexible electrolyte even if there is a substantial difference between the α coefficient of thermal expansion of the anode layer or the cathode layer and the α coefficient of thermal expansion of the electrolyte. These thinner anode and cathode layers can decrease the effect of the differences in the coefficients of thermal expansion mismatch, increasing the longevity of the fuel cell.

In yet another embodiment, the anode layer and/or the cathode layer the fuel cell assembly can be placed on the solid flexible electrolyte through “roll-to-roll processing.” The anode and cathode layer materials can be stored on a roll. The anode and cathode can be unrolled and the electrolyte can be placed against the unrolled portions of the anode layer material and the cathode layer material. The anode layer material and the cathode layer material can be bonded to the electrolyte and the anode layer material and the cathode layer material can be cut away from their respective rolls. Because the anode and cathode materials are flexible, anode and cathode layers will conform to the grooved surfaces of the electrolyte. The anode and cathode can be unrolled and a new electrolyte can be placed against the unrolled portions of the anode layer material and the cathode layer material.

In some embodiments, the form factor of the fuel cell can be produced on the order of standard macro-size form factor, or it may be formed into a micro-size form factor on the size order of a household battery. Any appropriate size, scale, shape, or configuration may be used, depending on application constraints and requirements.

If the different fuel cell layers have different α coefficient of thermal expansion, then each layer will expand by different amounts when the temperature of the fuel cell changes from ambient to an operating temperature of 400° C.-1,000° C. These differences in expansion will result in shear forces between the layers that can result in delamination failure of the fuel cell if the thermal expansion shear forces exceed the bonding strength of the adjacent layers. A fuel cell having a grooved pattern surface interface surfaces between the adjacent layers of the fuel cell can be more tolerant to thermal expansion than a fuel cell with planar layer interfaces.

The peaks and valleys of the grooved patterned interface can function as “expansion loops” that can accommodate the different thermal movements of the different fuel cell layers. Although layers of the fuel cell are semi-rigid, the grooved patterned interfaces will allow for more relative movement of the adjacent layers than a fuel cell having planar layers and planar interfaces. The peaks and valleys of the grooved patterned interface can reduce the stress loads on the interface of the adjacent layers of the fuel cell. The expansion of the different layers can result in very small changes in the angles between the peaks and valleys of the patterned grooved surface which is less likely to result in delamination than a fuel cell having adjacent layers that have planar interfaces.

The maximum power output of a fuel cell can be proportional to the area size of the 3 phase reaction boundary area. The surface area can be increased by forming grooves on the 3 phase reaction boundary area. For example, the grooved 3 phase reaction boundary area can provide three times as much surface area compared with fuel cells that have a planar 3 phase reaction boundary area for the same fuel cell size. By using a grooved 3 phase reaction boundary area in the fuel cell, the power output can be two times higher for substantially the same size fuel cell. In other words, the inventive fuel cell can have two times the power density compared to known fuel cells due to the larger 3 phase boundary surface area. Because of this larger grooved 3 phase reaction boundary area 221, the fuel cell 200 shown in FIG. 4 can output two times the power output of the fuel cell assembly 150 with the planar 3 phase reaction boundary area 121.

FIG. 5 illustrates an embodiment of a fuel cell assembly 150 that has an anode 103, a cathode 107, and a solid flexible electrolyte 105 that have planar surfaces. In this embodiment, the 3 phase reaction boundary area 121 at the interface of the cathode 107, and the electrolyte 105 is also planar. The power output density of the fuel cell assembly 150 can be proportional to the 3 phase reaction boundary area. For fuel cells having the same physical size, a grooved 3 phase reaction boundary area 221 shown in FIG. 4 will have a larger 3 phase reaction boundary area and a larger higher power output density than a planar 3 phase reaction boundary area 121 shown in FIG. 5. In some embodiments, the grooved 3 phase reaction boundary area 221 shown in FIG. 4 may have a surface area that is up to three times larger than the 3 phase reaction boundary area 121 shown in FIG. 5.

The components of the inventive fuel cells can be fabricated from carbon particles such as graphene or carbon nano-onions that can be decorated with conductive materials. Graphene is an allotrope of carbon consisting of a single layer of atoms arranged in a lattice. Graphene has a high tensile strength and high electrical conductivity and is the thinnest two-dimetisional material. Carbon nano-onions can be multi-layer fullerenes that are carbon atoms connected by single and double bonds so as to form a closed or partially closed mesh, with fused rings of five to seven atoms. The molecule may be a hollow spherical shape having multiple onion layers of carbon.

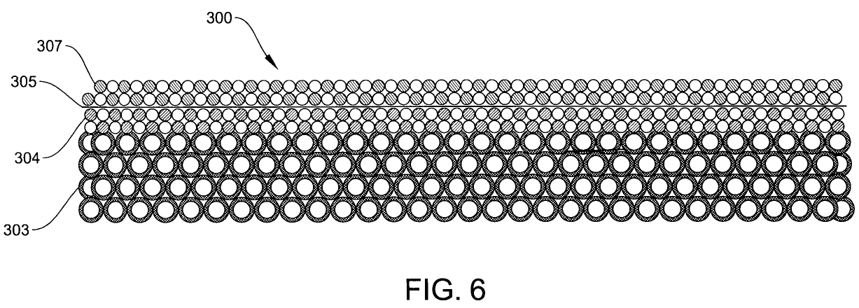

FIG. 6 illustrates an embodiment of a fuel cell 300 that more clearly illustrates the carbon particle configuration. Each carbon particle is illustrated as a circular structure that has a conductive material decoration. Electrolyte particles can be pressed and sintered to a required porosity and density. The electrolyte particles can be pressed in a mold to form the electrolyte layer 305. The electrolyte layer 305 can be removed from the mold and exposed to microwaves to sinter the electrolyte layer 305 to fuse the adjacent electrolyte particles at their contact points.

Cathode particles are deposited on a cathode facing side of the electrolyte 305 to form a cathode layer 307. The cathode particles can be carbon particles that are decorated with a cathode conductive material. In some embodiments, the cathode layer 307 can be spray deposited onto the cathode facing side of the electrolyte 305. The cathode layer 307 can be sintered to fuse the adjacent cathode particles at their contact points.

Functional anode particles are deposited on an anode facing side of the electrolyte 305 to form a functional anode layer 304. The functional anode particles can be carbon particles that are decorated with a functional anode conductive material. Anode particles are deposited on the exposed surface of the functional anode layer 304. The anode particles can be carbon particles that are decorated with an anode conductive material. The functional anode layer 304 can be spray deposited onto the anode facing side of the electrolyte 305 and the anode layer 303 can be spray deposited onto the functional anode layer 304. The functional anode layer 304 and the anode layer 303 can be microwave sintered so that the particles are fused together at their contact points. ‘

In addition to sintering, microwave energy can also be used to perform other fuel cell process steps. For example, microwave energy can be used to alter and control the porosity and density of the fuel cell components. Higher heat and longer exposure will result in more melting and fusing of the materials which can result in lower porosity and higher density. The microwave energy processing can also be used to anneal the fuel cell components.

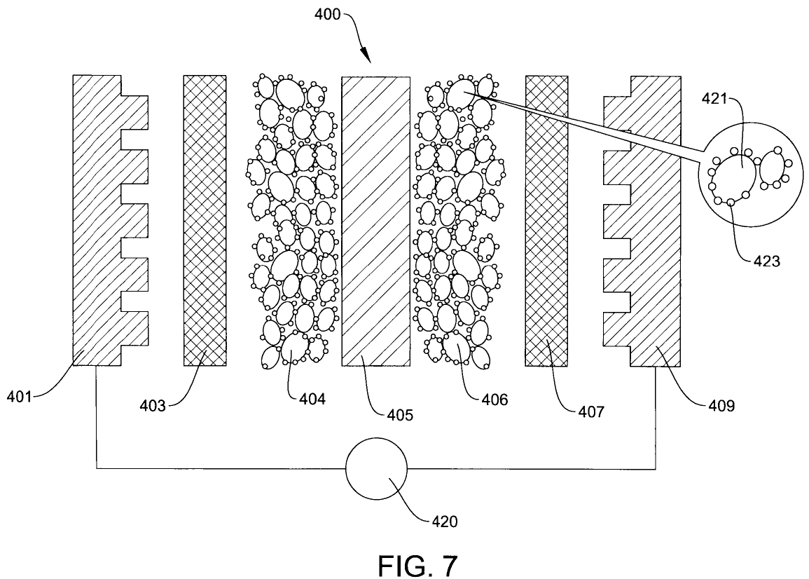

FIG. 7 illustrates another embodiment of a fuel cell 400 having an anode separator 401, an anode gas diffusion layer 403, an anode catalyst layer 404, a solid flexible electrolyte membrane 405, a cathode catalyst layer 406, a cathode gas diffusion layer 407, and a cathode electrode separator 409. One or more of the fuel cell 400 components of the fuel cell 400 can be formed from metal decorated graphene. The fuel cell 400 components include: an anode separator 401, an anode gas diffusion layer 403, an anode catalyst layer 404, a solid flexible electrolyte membrane 405, a cathode catalyst layer 406, a cathode gas diffusion layer 407, and a cathode electrode separator 409. Each of the fuel cell 400 components can have a different metal decoration, porosity, and density.

On the anode side of the fuel cell 400, a fuel gas source can be coupled to the anode electrode separator 401 that can have a grooved surface that forms flow passages for the fuel gas that can be hydrogen gas. The fuel gas can flow from a fuel source through the grooves of the anode electrode separator 401 to the anode gas diffusion layer 403. The anode gas diffusion layer 403 can facilitate uniformity of the fuel gas flow to the anode catalyst layer 404 so that the fuel gas is evenly distributed and can flow evenly through the anode catalyst layer 404. The anode catalyst layer 404 can accelerate the chemical reaction on the fuel anode.

On the cathode side of the fuel cell 400, ambient oxygen gas can flow through the cathode electrode separator 409 that can have a grooved surface that forms flow passages for the oxygen gas into the fuel cell 400. The oxygen gas can flow through the grooves of the cathode electrode separator 409 to the cathode gas diffusion layer 407. The cathode gas diffusion layer 407 that can homogenize the oxygen gas flow to the cathode catalyst layer 406 so that the oxygen gas is evenly distributed and can flow evenly through the cathode catalyst layer 406. The cathode catalyst layer 406 can accelerate the chemical reaction on the air cathode.

In a solid oxide fuel cell configuration, the solid flexible electrolyte membrane 405, oxygen ions can allow oxygen ions (O²⁻) from the cathode catalyst layer 406 to permeate through the electrolyte membrane 405 and combine with the hydrogen from the fuel anode catalyst layer 404 forming water. At the same time, electrons flow from the anode electrode separator 401 to the cathode electrode separator 409 through an external circuit, producing direct current electricity.

In other configurations, the solid flexible electrolyte membrane 405 can allow oxygen ions (O²⁻), to move between the anode catalyst layer 404 and cathode catalyst layer 406 sides of the fuel cell 400. At the anode catalyst layer 404 a catalyst causes the hydrogen fuel to undergo oxidation reactions that generate positively charged hydrogen ions and electrons. The hydrogen ions can move from the anode side to the cathode side through the electrolyte membrane 405 and at the cathode catalyst layer 406, another catalyst causes the hydrogen gas to form hydrogen ions (protons) and electrons. The hydrogen ions react with the oxygen forming water. At the same time, electrons flow from the anode electrode separator 401 to the cathode electrode separator 409 through an external circuit 420, producing direct current electricity.

The anode gas diffusion layer 403 can also control the H₂O (steam and/or water) flow that can maintain the H₂O content of the fuel cell 400 to a suitable level. More specifically, the anode gas diffusion layer 403 can remove by-produced water outside of the anode catalyst layer 404 and prevent flooding while keeping some water on surface for conductivity through the solid flexible electrolyte membrane 405. The anode gas diffusion layer 403 can also provide heat transfer during cell operation to remove the heat from the electrolyte membrane 405 during operation.

The three dimensional components of the fuel cell 400 can be made from homogeneous metal decorated graphene. This construction can enable various benefits. The homogeneous metal decorated graphene fuel cell components are more robust throughout the stack of the assembly creating a more durable and stronger fuel cell 400. The solid flexible electrolyte created from graphene particles decorated with chitosan can create a proto-exchange membrane fuel cell that produce a much higher power density. A proto-exchange membrane electrolyte created from graphene decorated with chitosan can increase proton conductivity by more than 500% compared to electrolytes created from pure chitosan. A proto-exchange membrane electrolyte created from graphene decorated with chitosan can also be less expensive than electrolytes created from pure chitosan. The enhanced proton conductivity of the electrolyte due to the graphene decorated with chitosan construction results in a fuel cell having a higher power density.

The configuration of the fuel cell 400 can provide various functional benefits. The cathode gas diffusion layer 407 can help to control the water flow to maintain water content of the fuel cell 400 to a suitable level. More specifically, the anode gas diffusion layer 403 can remove water produced by the anode catalyst layer 404 and prevent flooding while keeping some water on surface for conductivity through the electrolyte membrane 405, The anode gas diffusion layer 403 can also provide heat transfer during cell operation to remove the heat from the electrolyte membrane 405 during operation.

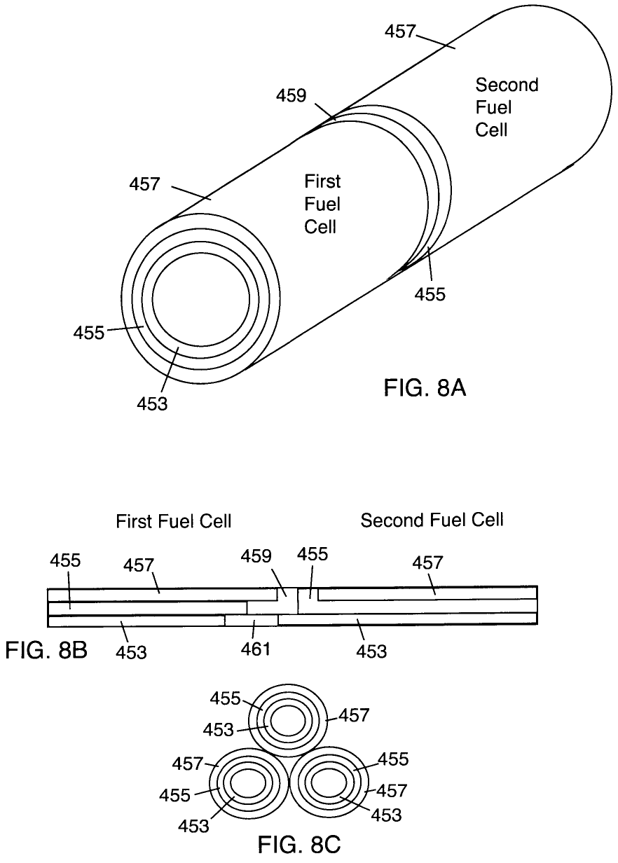

The fuel cells have been described as flat structures with multiple substantially planar component layers. In other embodiments, fuel cell construction can be fabricated that can have a tubular or cylindrical structure. FIG. 8A illustrates a perspective view of a cylindrical fuel cell assembly having tubular anodes 457, electrolytes 455, and cathodes 453. The solid flexible electrolytes 455 can be fabricated from electrolyte particles that are pressed in a tubular mold and exposed to microwaves that burn off binder materials and sinter the adjacent electrolyte particles to create the cylindrical electrolytes 455. The cathode layers 453 can be spray deposited on the inner surfaces of the solid flexible electrolytes 455 and the anode layers 457 can be spray deposited on the outer surfaces of the solid flexible electrolytes 455. The cathode layers 453 and the anode layers 457 can be exposed to microwaves that burn off binder materials and sinter the adjacent anode and cathode particles to create a tubular or cylindrical fuel cell.

During operation of the tubular fuel cell, hydrogen gas fuel can pass over the outer surfaces of the fuel cell and through the porous anode layer 457 to the electrolyte 455. Air can flow through the center orifice and oxygen can pass through the porous cathode layer 453 to the electrolyte 455. Oxygen ions (2O²⁻) can pass through the solid flexible electrolyte 455 and combine with the hydrogen (H) to form water (H₂O). Electrical energy is generated between the anode layer 457 and the cathode layer 453.

With reference to FIGS. 8A and 8B, in some embodiments, multiple fuel cells can be constructed in series on the same single tubular fuel cell assembly. In the illustrated example, the cathode layers 457 of the two adjacent fuel cells can be separated by interconnects 459 and electrolytes 455. FIG. 8B illustrates a cross section of a portion of the tubular two fuel cell assembly. The interconnects 459 can electrically couple the anode layer 457 of a first fuel cell to the cathode layer 453 of a second adjacent fuel cell. The interconnects 459 can also separate the adjacent electrolytes 455 of the adjacent fuel cells. The insulators 461 can separate the cathode layers 457 of the adjacent fuel cells. The material removal and deposition of the components of the illustrated tubular fuel cell assembly can be processed through micromachining or other etching processes such as laser material removal. While two fuel cells are illustrated in this example, in other embodiments, any number of fuel cells can be assembled and coupled in series in the same tubular assembly structure.

Multiple tubular fuel cell assemblies can also be arranged in a parallel configuration. With reference to FIG. 8C, three tubular fuel cell assemblies are arranged in parallel. The tubular fuel cell assemblies can be electrically coupled in series to increase the cumulative voltage output or alternatively, the tubular fuel cell assemblies can be electrically coupled in parallel. As discussed, fuel cells can have a lower voltage output therefore electrically coupling the fuel cells in series can increase the cumulative voltage output to a level that is compatible with more electrical devices.

The anode catalyst layer 404 and the cathode catalyst layer 406 are illustrated as carbon particles 421 that are decorated with conductive materials 423. The anode catalyst layer 404 and the cathode catalyst layer 406 can be spray deposited onto opposite sides of the solid flexible electrolyte. The anode catalyst layer 404 and the cathode catalyst layer 406 can then be sintered. In some embodiments, the sintering can be performed with micro-wave energy. The conductive materials 423 on the carbon particles 421 can be heated and fused together at their contact points during the sintering process. The anode catalyse layer 404 and the cathode catalyst layer 406 can have a higher porosity and a lower density than the other components of the fuel cell 400.

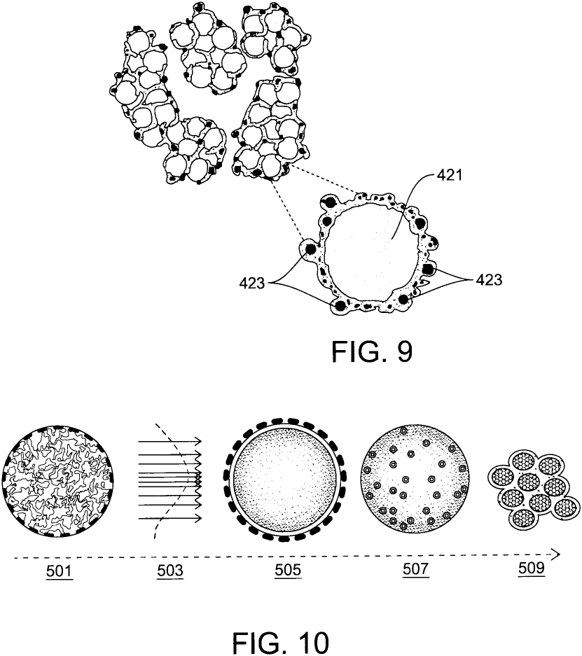

In different embodiments, some or all of the fuel cell components can be built with three dimensional metal decorated carbon particles. With reference to FIG. 9, carbon particles 421 decorated with conductive materials 423 are illustrated. The carbon graphene particles 421 can be granular materials that are each discrete solid structures. The conductive materials 423 are much smaller than the carbon particles 421 and are attached to the outer surfaces of the carbon particles 421.

The initial carbon particles can be a porous media with a larger diameter (e.g., 10 microns, or 1 micron), and these particles can be broken during formation of the SCM such that the porous carbon media particle size is smaller (e.g., less than 1 micron, or less than 100 nm) in the formed SCM. The porous media can be any shape that provides a high porosity, such as mesoporous structures or hierarchical structures (i.e., structures with small and large features).

The SCMs can contain different combinations of porous media, conductive particles, electrically conductive materials (ECMs), and/or active materials. An ECM can be conformally decorated (e.g., deposited, coated) on the surfaces and/or within the pores of the carbon particle media. In some embodiments, the SCMs containing the porous media and the ECM, can have an electrical conductivity greater than 500 siemens per meter (S/m), or greater than 2,000 S/m, or from 500 S/m to 5,000 S/m, or from 500 S/m to 20,000 S/m. In some cases, the electrical conductivity of the SCMs is measured after compression, sintering, and annealing. In some embodiments, the SCMs containing the porous media and the ECM, as described above, have an electrical sheet resistance less than 1 ohm/square, or less than 100 Ohm/square, or between 1 Ohm/square and 100 Ohm/square, or between 1 Ohm/square and 10,000 Ohm/square, or between 1 Ohm/square and 100,000 Ohm/square. In some cases, the sheet resistance of the SCMs is measured by forming a film (e.g., when the SCMs are formulated into a slurry with a volatile solvent, coated, and dried), and using a four-point probe measurement, or an eddy current based measurement.

SCMs with high electrical conductivity can be created by vapor depositing metals onto the clusters in such a way as to prevent pore surface clogging of the carbon particle media. In some applications, these high-conductivity SCMs are slurry deposited (i.e., as inks or toners for printers). Optionally, a heated calendaring roller can compress and melt the metals in the SCM particles together to connect the porous media (e.g., graphene containing carbon material) without the use of binders. In some cases, the SCM particles can be exposed to microwave radiation that can be used to melt a low melting point ECM (e.g., silver, or antimony), thereby embedding the porous media of the SCM particles in a highly conductive metal matrix.

The thickness of the ECM deposited decorations on the surfaces and/or within the pores of the carbon particle porous media, can have a thickness from 1 monolayer (e.g., less than 1 nm thick) to several layers thick (e.g., less than a few nanometers thick). In other cases, the thickness of the ECM deposited decorations on the surfaces or within the pores of the carbon particle porous media can have a thickness from 1 nm to 100 nm thick, or from 0.1 microns to 100 microns.

In some cases, the carbon particle porous media can be pre-treated before being decorated with the ECM. Some examples of pre-treatments are chemical etches, plasma etches, mechanical size reduction, or combinations of chemical and mechanical processes. Some non-limiting examples of pre-treatments include mechanical processing, such as ball milling, grinding, attrition milling, micro-fluidizing, jet milling, and other techniques to reduce the particle size without damaging the carbon allotropes contained within. Other examples of pre-treatments include exfoliation processes such as shear mixing, chemical etching, oxidizing (e.g., Hummer method), thermal annealing, doping by adding elements during annealing (e.g., S, and N), steaming, filtering, and lypolizing, among others. Other examples of pre-treatments include sintering processes such as SPS (Spark Plasma Sintering, i.e., Direct Current Sintering), microwave, microwave plasma, and UV (ultraviolet), which can be conducted at high pressure and temperature in an inert gas. In some embodiments, multiple pre-treatment methods can be used together or in series. These pre-treatments can be useful to modify the morphologies and/or surfaces of the carbon particle porous media before applying the ECM decorations. For example, pre-treatments can change the surface energy of the carbon particle porous media so the ECM can more effectively penetrate into the small pores of the carbon particle porous media.

The carbon particle porous media can be decorated with an active material can then be deposited on the surfaces and/or within the pores of the carbon particle porous media and then optionally coated with the ECM. The resulting material is an SCM with a carbon particle porous media that is optionally decorated with an ECM and an active material. The active material can be deposited using any conformal deposition technique capable of depositing the active material on the surfaces and/or within the pores of the porous media optionally coated with the ECM. Some examples of conformal deposition techniques that can be used to deposit the active material are solution deposition techniques (e.g., chemical bath deposition, sol-gel deposition, particle printing, etc.) and vapor deposition techniques (e.g., sputtering, evaporation, chemical vapor deposition, atomic layer deposition (ALD), etc.).

The carbon particle and/or the ECM porous media can have a high porosity and can be decorated with an active material that can penetrate into the pores can occupy a large volume of the SCM. In some embodiments, the mass fraction of the active material compared to the total mass of the SCM is greater than 20%, or greater than 40%, or greater than 60%, or greater than 80%, or from 10% to 90%, or from 50% to 90%, or from 60% to 90%.

In some embodiments, the active material will alloy with the material in the carbon particle porous media or the materials in the carbon particle porous media coated with the ECM. For example, in some processes, the active material is deposited at an elevated temperature, which can melt or partially melt the carbon particle porous media and/or conductive particles and the active material will alloy with the underlying materials upon deposition. In other cases, the carbon particle porous media and/or conductive particles will not melt or will partially melt during the active material deposition, but the elevated temperatures enable the active material to diffuse into the underlying materials causing some degree of alloying between the active materials and underlying materials.

In some embodiments, coating the carbon particle porous media with other films (i.e., an ECM and/or active material) will densify carbon particle the porous media by filling in some of the voids (i.e., pores) in the core material. The same can be true for other examples of film deposition on the carbon particle porous materials described herein. Furthermore, the act of sintering (welding or coalescing) can also densify the less dense carbon particle porous materials into a denser SCM.

In some embodiments, the carbon particle porous media has a high electrical conductivity (e.g., a conductive carbon allotrope), as described above. In such cases, the coating of additional ECMs may or may not be required. In some embodiments, the carbon particle porous media, is itself an active material. In such cases, the coating of additional active materials may or may not be required.

FIG. 10 illustrates an embodiment of a process for microwave sintering of the carbon graphene particles that may or may not be decorated with conductive materials is illustrated. The carbon particles can be coupled to each other to create the different components of the fuel cell 501. In an embodiment, the metal decorated carbon particles can be pressed together in a pressurized mold, spray deposited to form a component layer of the fuel cell structure, or bonded together in any other suitable method. The carbon particles can also be known as a “carbon nano onion” that is decorated with a conductive material or not decorated.

The carbon particles in the fuel cell component layers can be exposed to microwave energy 503 in a microwave processing chamber that permits selective heating of a wide variety of materials, conductors and dielectrics. Through materials engineering of size, conductivity and/or loss tangent it is possible to configure the fuel cell component particles so that they selectively absorb microwave radiation allowing highly localized control over sintering of materials through local temperature control. The controlled microwave energy exposure allows the outer surfaces of the particles to be sintered without overheating the cores of the particles. More specifically, during microwave processing, the central core of the particles can remain at a relatively low temperature while core shell or the temperature of the surrounding decorations is much higher.

The selective heating of the fuel cell component particles allows the adjacent particles to be bonded to each other and sintered without over-diffusion of the surface materials. The microwaves direct electro-magnetic energy at the carbon particles that can heat the carbon particles. The carbon particles can absorb the electro-magnetic energy that results in electrical currents and ohmic heating 505. The microwave energy can heat the exterior surfaces to a higher temperature than the center core of the carbon particles 507. If the carbon particles are decorated with metal particles, the metal decorations can absorb the electro-magnetic energy than the carbon particles so that the metal decorations can become hotter than the carbon particle. The temperatures of the exterior surfaces can rise above a melting temperature of the materials and the particles can be sintered and the adjacent particles can be fused to each other at their contact points 509. The microwave processing allows the fuel cell components particles to be sintered much faster than traditional sintering furnaces.

The component construction with carbon graphene particles that are decorated with conductive materials or undecorated results in fuel cell components that have higher surface areas than known fuel cells. The power density for the fuel cell can be increased with higher porosity and higher surface area. Thus, the component construction with carbon graphene particles as described above, can also result in better control of the porosity. By optimizing the porosity and surface area, the power density of the fuel cell can be improved and optimized.

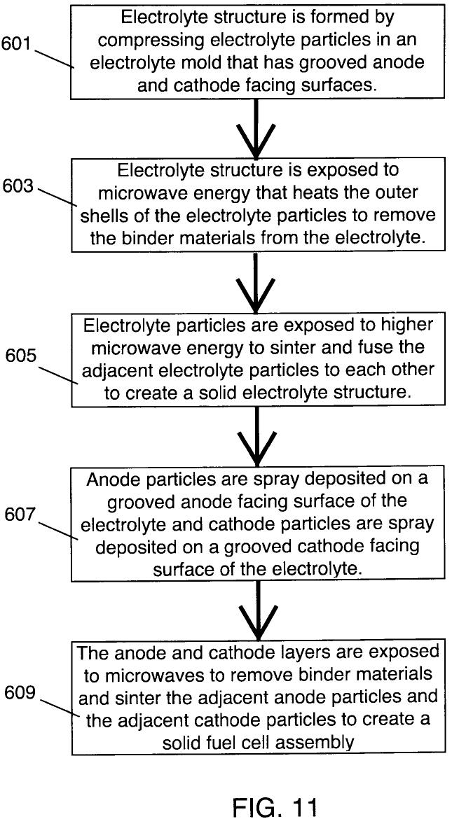

FIG. 11 is a flowchart of an embodiment of a process for fabricating an embodiment of the inventive fuel cell. The solid flexible electrolyte is formed by compressing electrolyte particles in an electrolyte mold that has grooved anode and cathode facing surfaces 601. The molded electrolyte structure is then exposed to microwave energy that heats the outer shells of the electrolyte particles to remove the binder materials from the electrolyte 603. Electrolyte particles are exposed to higher microwave energy to sinter and fuse the adjacent electrolyte particles to each other to create a solid electrolyte structure 605. Microwave energy can also be used to anneal the electrolyte.

Anode particles can be spray deposited on a grooved anode facing surface of the electrolyte and cathode particles are spray deposited on a grooved cathode facing surface of the electrolyte 607. The anode and cathode layers are exposed to microwaves to remove binder materials and sinter the adjacent anode particles and the adjacent cathode particles to create a solid fuel cell assembly 609. Microwave energy can also be used to drive off the binder materials from the anode and cathode layers and anneal the anode and cathode layers.

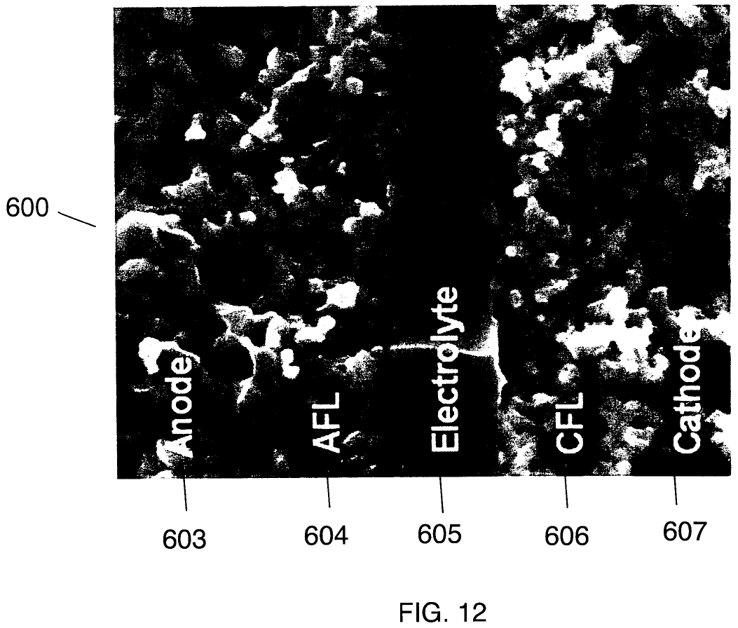

FIG. 12 is a photograph of a cross section of a fuel cell 600 having an anode 603, an anode functional layer (AFL) 604, an electrolyte 605, a cathode functional layer (CFL) 606, and a cathode 607. The anode 603 and AFL 604 can be fabricated from carbon particles that are decorated with conductive anode materials. The cathode 607 and CFL 606 can be fabricated from carbon particles that are decorated with conductive cathode materials. The anode 603 and anode functional layer 604 form a porous structure from carbon particles decorated with sintered conductive anode materials. The decorated carbon particles are fused together at their contact points. Similarly, the cathode 607 and the cathode functional layer 606 form a porous structure from carbon particles decorated with conductive cathode materials that have been sintered. The decorated carbon particles are fused together at their contact points. In contrast to the other components, the electrolyte 605 has a higher density and a lower porosity than the anode 603, the AFL 604, the CFL 606, and the cathode 607. The AFL 604 can be fused to the anode facing surface of the electrolyte 605 and the CFL 606 can be fused to the cathode facing surface of the electrolyte 605 at a 3 phase reaction boundary area.

The inventive fuel cell fabrication process is faster and more energy efficient than known fuel cell fabrication processes. It can currently take several days to fabricate fuel cells. In contrast, the fabrication time for the inventive fuel cell components can be completed in several minutes. Traditional fuel cells require long duration high temperature processing which requires substantial amounts of energy. Because the inventive fabrication processes use microwave energy for sintering, a much lower quantity of energy is required.

Known methods for fuel cell fabrication utilize industrial furnaces to heat and sinter the electrolyte particles. The electrolytes are formed from ceramic powder particles that are pressed into discs. It can take several hours for the internal heat of the furnace to be ramped up to the required processing temperature. Once the proper temperature is reached, the electrolyte particle discs are then placed into the industrial furnace. The electrolyte particle discs may need remain in the furnace for 24 or more hours to drive off the binders that hold the electrolyte particles together. The furnace heat is then further ramped up to the sintering temperature and the electrolyte particle discs are heated at the higher temperature for another 24 hours or longer to perform the sintering of the electrolyte particles. Once the electrolyte particles are sintered, the furnace temperature is slowly ramped down to an ambient temperature over 8-24 hours.

The electrolyte discs are then slip cast to attach the anode and cathode to opposite sides of the electrolyte discs to create the fuel cell structures. The described furnace heating process is then repeated on the fuel cell structure with the internal heat of the furnace being ramped up over hours and then held at a temperature that is sufficient to drive off the binders in the anode and cathode layers. The furnace heat is then ramped to the sintering temperature (approximately 1400° C., depending on the materials being sintered) and the fuel cell structure is held at this temperature for 24 hours or longer to perform the sintering of particles in the anode and cathode layers. Once the anode and cathode particles are sintered, the furnace temperature is slowly ramped down to an ambient temperature over an additional 8-24 hour period to complete the fuel cell. The fabrication and furnace processing of known fuel cells can cumulatively take several days to complete and require a substantial amount of energy to heat the furnace. In contrast to the furnace processing of prior art fuel cells, the inventive microwave processing is much more energy and time efficient. Thus, the inventive fuel cell fabrication process is both faster and less costly.

In some embodiments, a dense electrolyte structure provides a backbone for the mechanical integrity of the fuel cell assembly. In some embodiments, the structural electrolyte component is manufactured from decorated or undecorated carbon particles such as graphene. The carbon particles can be decorated with ionic conducting ceramic materials such as yttria-stabilized zirconia (YSZ) or gadolinia-doped ceria (GDC), or other suitable materials.

In various embodiments, the electrolyte can be made with either in-situ or ex-situ microwave energy dosing for rapid thermal annealing. Using a solid electrolyte in the fuel cell can allow the thickness of the anode and cathode dramatically thinner which can reduce the reactant transport resistance through the electrodes. Microwave energy can also be used to: enhance the fuel cell component material density, remove unwanted materials impurities, and reduce residual stresses in the bulk fuel cell component materials that are produced.

The fuel cell electrolytes can have high area-specific resistances (ASR) due to long ionic conduction paths through the thick electrolyte. In some embodiments, it can be desirable to have thinner electrolytes that still provides the required mechanical strength. The anode facing and cathode facing surfaces of the electrolytes can be processed by micromachining to form the desired pattern of grooves described above. The micromachining for the electrolytes of the fuel cell can be similar to the micromachining used in plasma display manufacturing that includes micro surface channeling and 3D surface architecture formation. Micromachining of the electrolyte and possibly other components is cost-effective and a viable alternative to chemical plasma etching methods known in semiconductor fabrication technologies. As discussed, fuel cells can benefit from this surface processing by enlarging the reaction surface areas including the interfaces between the anode and the electrolyte and the interfaces between the cathode and electrolyte (3 phase reaction boundary area) by several hundred percent.

### Carbon Particles

As discussed, the components of the fuel cell can be fabricated from carbon particles that can be decorated or undecorated. Surface decoration on carbon structures have the benefit of creating fuel cell structures that have higher porosity as well as higher proton and electrical conductivity. In some embodiments, the ceramic particles used to create each of the fuel cell components (anode, cathode, and electrolyte) are metal decorated graphene particles that can be produced by a methane reactor that converts methane into hydrogen and carbon particles. The methane reactor can have a processing chamber where the carbon particles can be decorated. The anode, cathode, and electrolyte fuel cell components can be fabricated from carbon particles that are decorated with different anode, cathode, and electrolyte material decorations.

The carbon particles that form the anode, cathode, and electrolyte, can be carbon or graphene particles that are decorated with various anode, cathode, and electrolyte materials. Conductive anode materials, conductive cathode materials, and conductive electrolyte materials can be used to decorate the carbon particles to form the anode particles, cathode particles, and electrolyte particles. The decorative conductive anode materials, conductive cathode materials, and/or conductive electrolyte materials can include: lithium-containing compounds; elemental sulfur, sulfur containing compounds, lithium nickel cobalt manganese oxide (NMC), lithium iron phosphate (LFP), boron, bromine, platinum, nickel, silver, molybdenum, iron, or any combination thereof. The carbon particles can be decorated with materials in various states such as: solid, metal molten liquid, suspension, dissolved solution, or any combination thereof. The decorations on the carbon particles can also include surfactant materials that can reduce pore clogging of the electroactive decoration materials. Possible surfactant materials can include: silver, antimony, amorphous carbon, hydroxy functional groups, or any combination thereof.

In some embodiments, the cores of the anode, cathode, and/or electrolyte particles can be fabricated from a plurality of aggregates that can include carbon nanoparticles such as graphene-containing allotropes, graphite, graphene platelets, spherical fullerenes, connected spherical fullerenes, graphene-coated spherical fullerenes, graphene platelets, carbon nanotubes, carbon nano onions (CNOs), amorphous carbon, or any combination thereof.

In some embodiments, the carbon particles can have high compositional purity, high electrical conductivity, and a high surface area. In some embodiments, the carbon particles also have a structure that is beneficial for specific applications. In some cases, a mesoporous structure can be characterized by a structure with a wide distribution of pore sizes (e.g., with a multimodal distribution of pore sizes). For example, a multimodal distribution of pore sizes can be indicative of structures with high surface areas and a large quantity of small pores that are efficiently connected to the substrate and/or current collector via material in the structure with larger feature sizes (i.e., that provide more conductive pathways through the structure).

In some embodiments, the particulate carbon materials contained in the porous media and/or conductive particles described herein are produced using microwave plasma reactors and methods, such as any appropriate microwave reactor and/or method described in U.S. Pat. No. 9,812,295, entitled “Microwave Chemical Processing,” or in U.S. Pat. No. 9,767,992, entitled “Microwave Chemical Processing Reactor,” which are assigned to the same assignee as the present application, and are incorporated herein by reference as if fully set forth herein for all purposes. Additional information and embodiments for microwave plasma gas processing system methods and apparatuses to produce the carbon nanoparticles and aggregates described herein are also described in the related U.S. patents and patent applications mentioned in this application.

In some embodiments, the particulate carbon materials in the porous media and/or conductive particles described herein are described in U.S. Pat. No. 9,997,334, entitled “Seedless Particles with Carbon Allotropes,” which is assigned to the same assignee as the present application, and is incorporated herein by reference as if fully set forth herein for all purposes. In some embodiments, the particulate carbon materials contain graphene-based carbon materials that comprise a plurality of carbon aggregates, each carbon aggregate having a plurality of carbon nanoparticles, each carbon nanoparticle including graphene, optionally including multi-walled spherical fullerenes, and optionally with no seed particles (i.e., with no nucleation particle). In some cases, the particulate carbon materials can be produced without using a catalyst. The graphene in the graphene-based carbon material has up to 15 layers.

In some embodiments, a ratio percentage of carbon to other elements in the carbon particle aggregates can be greater than 99%. A median size of the carbon aggregates can be from 1 micron to 50 microns, or from 0.1 microns to 50 microns. A surface area of the carbon aggregates is at least 10 m²/g, or is at least 50 m²/g, or is from 10 m²/g to 300 m²/g, or is from 50 m²/g to 300 m²/g. The carbon aggregates, when compressed, can have an electrical conductivity greater than 500 siemens per meter (S/m), or greater than 5000 S/m, or from 500 S/m to 20,000 S/m.

In some embodiments, the carbon particles in the porous media and/or conductive particles described herein are also described in U.S. Pat. No. 9,862,606 entitled “Carbon Allotropes,” which is assigned to the same assignee as the present application, and is incorporated herein by reference as if fully set forth herein for all purposes. In some embodiments, the carbon particles can include carbon nanoparticles comprising at least two connected multi-walled spherical fullerenes, and layers of graphene coating the connected multi-walled spherical fullerenes. Additionally, the carbon allotropes within the carbon nanoparticles can be well ordered. For example, a Raman spectrum of the carbon nanoparticle using 532 nm incident light can have a first Raman peak at approximately 1350 cm⁻¹ and a second Raman peak at approximately 1580 cm⁻¹, and a ratio of an intensity of the first Raman peak to an intensity of the second Raman peak is from 0.9 to 1.1. In some cases, the atomic ratio of graphene to multi-walled spherical fullerenes is from 10% to 80% within the carbon nanoparticles.

### Methods of Manufacture

In some embodiments, the particulate carbon materials described herein can be produced using thermal cracking apparatuses and methods, such as any appropriate thermal apparatus and/or method described in U.S. Pat. No. 9,862,602, entitled “Cracking of a Process Gas,” which is assigned to the same assignee as the present application, and is incorporated herein by reference as if fully set forth herein for all purposes. Additional information and embodiments for thermal cracking methods and apparatuses to produce the carbon nanoparticles and aggregates described herein are also described in the in the related U.S. patents and patent Applications mentioned in this disclosure.

In some embodiments, the carbon particles in the porous media and/or conductive particles contain more than one type of carbon allotrope. For example, the carbon particles can contain graphene, spherical fullerenes, amorphous carbon, and/or other carbon allotropes. Some of these carbon allotropes are further described in the related U.S. patents and patent applications mentioned in this disclosure. Additionally, the different carbon allotropes in the particulate carbon can have different morphologies, such as mixtures of low and high aspect ratios, low and high surface areas, and/or mesoporous and non-mesoporous structures. The use of carbon particles with combinations of different allotropes (and in some cases different morphologies) can enhance the electrical and mechanical properties of fuel cell components. The mass ratio of a first carbon allotrope (e.g., with high electrical conductivity and/or a mesoporous structure) to a second carbon allotrope (e.g., a long chain carbon allotrope) in the particulate carbon can be from 70:30 to 99:1, or from 80:20 to 90:10, or from 85:15 to 95:5, or is about 85:15, or is about 90:10, or is about 95:5. For example, mesoporous carbon allotropes in the particulate carbon can provide high surface area and/or high electrical conductivity, and the addition of long chain (i.e., high aspect ratio) carbon allotropes in the particulate carbon can improve the mechanical strength, adhesion and/or durability of the electrolyte, cathode, and/or anode layers of the fuel cell.

In some embodiments, the carbon particles in the porous media and/or conductive particles contains particles containing graphene (e.g., with one or more of the properties described herein), and particles containing long chain carbon allotropes (e.g., spherical fullerenes connected in a string-like arrangement, or carbon nanotube bundles). In some embodiments, the long chain carbon allotropes have aspect ratios greater than 10:1, or from 10:1 to 100:1, or about 10:1, or about 20:1, or about 50:1, or about 100:1. In some embodiments, the long chain carbon allotropes have dimensions from 50 nm to 200 nm wide by up to 10 microns in length, or from 10 nm to 200 nm wide by from 2 microns to 10 microns in length. Additional particles containing long chain carbon allotropes are described in the related U.S. patents and patent Applications mentioned in this disclosure. The mass ratio of a graphene-containing carbon allotrope to a long chain carbon allotrope in the particulate carbon can be about 85:15, or about 90:10, or about 95:5. In some embodiments, the long chain carbon allotropes can interlock with other conductive (and in some cases structured, or mesoporous) carbon allotropes in the particulate carbon and can form an interlocked hybrid composite allotrope electrode with improved mechanical properties compared to electrodes without long chain carbon allotropes. In some embodiments, the addition of long chain (e.g., fibrous like) carbon increases the medium range (e.g., 1 micron to 10 microns) conductivity, and increases the distribution of the other carbon allotrope (e.g., prevents agglomeration of the other carbon allotrope, such as mesoporous graphene particles), while improving mechanical stability of the SCM.

The addition of long chain carbon allotropes can provide additional porosity around the carbon chain, which increases ion conductivity and mobility in the electrode. For example, the long chain carbons enable reduced calendering pressure during fuel cell fabrication, while maintaining the same (or better) mechanical stability (i.e., tolerance to delamination of the fuel cell layers) without long chain carbons that are calendered at higher pressures. Reduced calendering pressure can be advantageous because the higher porosity achieved using a lower pressure leads to increase ion conductivity and/or mobility. Additionally, in some embodiments, the addition of long chain carbon (e.g., fibers) can improve the elongation/strain tolerance. In some cases, the elongation/strain tolerance (e.g., the maximum strain to failure, or the amount of performance degradation for a given strain) can be increased by as much as 50%. In some structures in this example, the addition of long chain carbon allotropes to the particulate carbon enables the use of fewer binders, or the elimination of the binders.

In some embodiments, the carbon particle porous media and/or conductive particles can be doped with another material (e.g., H, O, N, S, Li, Cl, F, Si, Se, Sb, Sn, Ga, As, and/or other metals). Doping can be advantageous because it can tune the properties of the carbon particles. For example, doping with a metal can improve the conductivity of the carbon particles, and doping with oxygen can change the surface energy of the carbon particles. The described SCMs can include beneficial materials and structures for electrolytes, cathodes, and/or anodes in fuel cells.

In the present disclosure, compositions and methods for making metal-decorated 3D graphene are described. In some cases, the metal-decorated 3D graphenes are referred to as structured composite materials (SCMs). The terms “3D graphene” or “3D graphenes”, or “structured composite materials” are used interchangeably.

In various embodiments, the 3D graphenes can contain different combinations of porous media, conductive particles, electrically conductive materials (ECMs), and/or active materials. In some embodiments, the porous media provides a structural framework (or scaffold) and the ECM provides high electrical conductivity to the SCM. In some cases, the ECM is deposited on the surfaces and/or in the pores of the porous media and forms a continuous (or semi-continuous, with some disconnected regions and/or islands) matrix and/or a coating throughout the SCM. In some cases, the porous media and the conductive particles are coalesced (or, welded together) by depositing an ECM. The resulting SCMs contain the porous media and conductive particles embedded in a matrix of the ECM. In some cases, the active material is deposited on the surfaces and/or in the pores of the ECM and provides activity (e.g., energy storage capacity) to the SCM.

The present SCMs can be tailored for use in fuel cells, and/or as energy storage materials, electronic materials, optical materials, structural materials, and others. The chemical composition and morphology of the porous media, conductive particles and/or the ECM in the SCMs can be different in different configurations. For example, active materials can include materials for fuel cells, batteries, capacitors, sensors, inks, printed circuits, Internet of Things (IoT) applications, metamaterials for electromagnetic films, electrochemical sensors, and materials for impedance spectroscopy, aerospace applications, automotive industries, light absorbing applications, electro-optics systems, satellites, or telescopes. In some embodiments, the active material is deposited within the pores of the porous media, the pores of the conductive particles, and/or the pores of the ECM material, and the resulting SCMs have improved properties compared to conventional composites.

The terms nanostructured, micro-structured, and meso-structured materials, as used herein, are materials with physical features (e.g., pores, precipitates, particles, and fibers) with average sizes in the 1 nm to 10 nm range in the case of nanostructured materials, 100 nm to 10 micron range in the case of micro-structured materials, and with a wide distribution of sizes in the case of mesoporous materials.

Some non-limiting examples of active materials for the present SCMs are sulfur, sulfur compounds, silicon, silicon compounds, boron, bromine, and platinum, nickel, silver, molybdenum, and iron, however, the materials and methods described herein are applicable to many different active materials.

Throughout this disclosure, the SCMs are often described in the context of fuel cell applications (e.g., in electrolytes, anodes or cathodes), however, the examples above illustrate that the materials and methods described herein are applicable to many different applications.

In some embodiments, an SCM can contain porous media coated with ECM and can have a large surface area and very small pores. Conventionally, it can be difficult to deposit additional material (e.g., an active material) into very small pores, especially if those pores have high aspect ratios. In some embodiments, the surface characteristics of the partially formed SCM and the deposition method of the additional material enable the additional material to efficiently be deposited within the small pores of the SCM, even into pores with high aspect ratios. For example, the average pore size can be less than 50 nm or less than 10 nm or less than 5 nm, with an aspect ratio of 1: 10 (i.e., 10 times deeper than wide), or 1:5, or 1:2, or 1:1, and the additional material can fill more than 30%, or more than 40%, or more than 50%, or more than 60%, or more than 70%, or more than 80%, or more than 90% of the volume of the pore. In the case of a thin coating, then for the same pore sizes as above, the additional material coating can cover more than 30%, or more than 40%, or more than 50%, or more than 60%, or more than 70%, or more than 80%, or more than 90% of the surface area of the pore with the geometries described above.

In some embodiments, an initial coating of surfactant materials, such as silver, or antimony) are grown on the aforementioned materials to promote the additional material to fill the pores (e.g., with the geometries described above) without clogging. Tuning these surfactant materials (e.g., by varying coverage) can also be used to effectively tune the degree of pore volume filling of an additional material. In other examples, a thin wetting layer, such as a layer of amorphous carbon, or a surface functionalized with hydroxy groups, allows the additional material (especially if the additional material is a liquid) to more effectively infiltrate into the small pores.

In some embodiments, the porous media, conductive particles, and/or ECM can have a high surface area (e.g., greater than 50 m²/g), a high electrical conductivity (e.g., greater than 500 S/m), and/or a particular morphological structure (e.g., a mesoporous structure with a bi-modal pore size distribution, or with nanometer-scale pores interspersed within a 3D web of thicker more conductive branches). These properties can also be varied such that the SCMs are useful in different applications.

In some embodiments, the porous media, conductive particles, and/or ECM have a surface area, when measured using the Brunauer-Emmett-Teller (BET) method with nitrogen as the adsorbate (i.e., the “BET method using nitrogen”, or the “nitrogen BET method”) or the Density Functional Theory (DFT) method, that is from 50 to 300 m²/g, or from 100 to 300 m²/g, or from 50 to 200 m²/g, or from 50 to 150 m²/g, or from 60 to 110 m²/g, or from 50 to 100 m²/g, or from 70 to 100 m²/g.

In some embodiments, the porous media, conductive particles, and/or ECM have pore volumes greater than 0.1 cm³/g, or greater than 0.5 cm³/g, or from 0.1 cm³/g to 0.9 cm³/g, or from 0.2 to 10 cm³/g. The porous media, conductive particles, and/or ECM can contain pores with average pore diameters from 1 to 4.3 nm and pore volume per gram of 0.46 cm³/g, or average pore diameter of 8.3 nm and pore volume per gram of 0.31 cm³/g. In some embodiments, the porous media, conductive particles, and/or ECM can contain mixtures of microporous, mesoporous, or macro-porous materials with pore diameters from 1 nm to 10 nm, of from 1 nm to 50 nm, and pore volumes from 0.1 cm³/g to 1 cm³/g, or from 0.2 cm³/g to 10 cm³/g.

In some embodiments, the porous media and/or conductive particles are particles with approximate particle size (e.g., diameter in the case of spherical particles) less than 10 microns, or less than 1 micron, or less than 100 nm, or from 10 nm to 10 microns, or from 10 nm to 1 micron.

In some embodiments, the porous media, conductive particles and/or ECM have an electrical conductivity (e.g., when compressed into a pellet) greater than 500 S/m, or greater than 2000 S/m, or from 500 S/m to 5000 S/m, or from 500 S/m to 20,000 S/m. In some embodiments the porous media, conductive particles and/or ECM have an electrical sheet resistance less than 1 ohm/square, or less than 100 Ohm/square, or between 1 Ohm/square and 100 Ohm/square, or between 1 Ohm/square and 10,000 Ohm/square, or between 1 Ohm/square and 100,000 Ohm/square. In some cases, the electrical conductivity of the porous media, conductive particles and/or ECM is measured after compression (e.g., into a disk, pellet, etc.), or after compression followed by annealing. In some cases, the sheet resistance of the porous media, conductive particles and/or ECM have is measured by forming a film (e.g., by formulating particles into a slurry with a volatile solvent, coating, and drying), and using a four-point probe measurement, or an eddy current based measurement.

In different applications, the porous media can be electrically conductive, electrically insulating, or a semiconductor. A few non-limiting examples of porous media materials are carbon allotropes, silicon, silicon oxide, silica, diatomaceous earth, and silicon carbide; however, the materials and methods described herein are applicable to many different porous media materials. Throughout this disclosure, the porous media, conductive particles and/or ECM may be described as being composed of carbon allotropes, or carbon alloys, semiconductors, pure metals, or silicon, however, the materials and methods described herein are applicable to many different materials. For example, SCMs containing covetic materials (i.e., aluminum or copper intermixed with carbon) can be produced using plasma torch processing. The co-deposition within the plasma torch enables the formation of covetic materials.

In some embodiments, the porous media is composed of inorganic materials that are capable of withstanding high processing temperatures that are required for the downstream processes (e.g., greater than 500° C., or greater than 1000° C.). In other embodiments, the porous media is composed of materials with melting points and/or boiling points below the processing temperatures that are required for the downstream processes (e.g., greater than 500° C., or greater than 1000° C.). In some of these cases, the porous media will change phase in the downstream processes and intermix (e.g., melt-diffuse) with subsequently deposited materials.

In some embodiments, the ECM can be deposited on the porous media, and the porous media will change phase during the ECM deposition process. In some cases, the electrically conductive media and the porous media will intermix (e.g., melt-diffuse) during the ECM deposition process. In some cases, covetic materials can result from phase changes through the SCM production process, which allow the two components to effectively combine.

Reference has been made to embodiments of the disclosed invention. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended embodiments and their equivalents. These and other modifications and variations to the present invention may be practiced by those of ordinary skill in the art, without departing from the scope of the present invention, which is more particularly set forth in the appended embodiments. Furthermore, those of ordinary skill in the art will appreciate that the foregoing description is by way of example only, and is not intended to limit the invention.

What is claimed is:

1. A flexible fuel cell construction comprising:
a solid flexible electrolyte formed from a plurality of electrolyte particles, the solid flexible electrolyte having an anode-facing surface and a cathode-facing surface opposite the anode-facing surface;
a porous anode layer formed from a plurality of anode particles that are decorated with a conductive anode material wherein the plurality of anode particles are abutting to each other and the porous anode layer is adjacent to the anode-facing surface of the solid flexible electrolyte;
an anode electrode layer adjacent to the porous anode layer;
a porous cathode layer adjacent to the cathode-facing surface of the solid flexible electrolyte; and
a cathode electrode layer adjacent to the porous cathode layer.

2. The flexible fuel cell construction of claim 1 wherein the plurality of electrolyte particles and the plurality of anode particles are carbon particles.

3. The flexible fuel cell construction of claim 1 wherein the anode facing surface of the solid flexible electrolyte has a pattern of grooves and is non-planar.

4. The flexible fuel cell construction of claim 3 wherein the pattern of grooves on the anode facing surface of the solid flexible electrolyte is a molded surface.

5. The flexible fuel cell construction of claim 3 wherein the pattern of grooves on the anode facing surface of the solid flexible electrolyte is an etched surface.

6. The flexible fuel cell construction of claim 1 wherein a coefficient of thermal expansion of the porous anode layer is within 5% of a coefficient of thermal expansion of the solid flexible electrolyte.

7. The flexible fuel cell construction of claim 1 wherein the solid flexible electrolyte is a tubular structure.

8. A flexible fuel cell construction comprising:
a solid flexible electrolyte formed from a plurality of electrolyte particles, the solid flexible electrolyte having an anode-facing surface and a cathode-facing surface opposite the anode-facing surface;
a porous anode layer adjacent to the anode-facing surface of the solid flexible electrolyte;
an anode electrode layer adjacent to the porous anode layer;
a porous cathode layer formed from a plurality of cathode particles that are decorated with a conductive cathode material wherein the plurality of cathode particles are abutting to each other and the porous cathode layer is adjacent to the cathode-facing surface of the solid flexible electrolyte; and
a cathode electrode layer adjacent to the porous cathode layer.

9. The flexible fuel cell construction of claim 8 wherein the plurality of electrolyte particles and the plurality of cathode particles are carbon particles.

10. The flexible fuel cell construction of claim 8 wherein the cathode surface of the solid flexible electrolyte has a pattern of grooves and is non-planar.

11. The flexible fuel cell construction of claim 10 wherein the pattern of grooves on the cathode surface of the solid flexible electrolyte is a molded surface.

12. The flexible fuel cell construction of claim 10 wherein the pattern of grooves on the cathode surface of the solid flexible electrolyte is an etched surface.

13. The flexible fuel cell construction of claim 8 wherein a coefficient of thermal expansion of the porous cathode layer is within 5% of a coefficient of thermal expansion of the electrolyte.

14. The flexible fuel cell construction of claim 8 wherein the flexible fuel cell construction is a tubular structure.

15. A flexible fuel cell assembly construction comprising:
a plurality of adjacent fuel cells wherein each of the adjacent fuel cell comprises:
a solid flexible electrolyte formed from electrolyte particles, the electrolyte having an anode surface, and a cathode surface opposite the anode surface;
a porous anode layer coupled to the anode surface of the porous electrolyte;
an anode electrode layer coupled to the porous anode;
a porous cathode layer formed from a plurality of cathode particles that are decorated with a conductive cathode material wherein the plurality of cathode particles are sintered to each other and the porous cathode layer is coupled to the cathode surface of the electrolyte;
a cathode electrode layer coupled to the porous cathode layer; and
interconnects coupling the anode electrode layer to the cathode electrode layer for two or more of the plurality of adjacent fuel cells.

16. The flexible fuel cell assembly construction of claim 15 further comprising:
isolation gaps between each of the plurality of adjacent fuel cells that extends through the porous anode layer, the porous cathode layer, the anode electrode, and the cathode electrode.

17. The flexible fuel cell assembly construction of claim 15 further comprising:
isolation structures between each of the plurality of adjacent fuel cells that are positioned at ends of the porous anode layer, the porous cathode layer, the anode electrode, and the cathode electrode.

18. The flexible fuel cell assembly construction of claim 15 wherein the interconnects extend through the solid flexible electrolyte of each of the plurality of adjacent fuel cells.

19. The flexible fuel cell assembly construction of claim 15 wherein the plurality of electrolyte particles and the plurality of cathode particles in each of the plurality of adjacent fuel cells are carbon particles.

20. The flexible fuel cell assembly construction of claim 15 wherein the cathode surface of the solid flexible electrolyte in each of the plurality of adjacent fuel cells has a pattern of grooves and is non-planar.

21. The flexible fuel cell assembly construction of claim 20 wherein the pattern of grooves on the cathode surface of the solid flexible electrolyte in each of the plurality of adjacent fuel cells is a molded surface.

22. The flexible fuel cell assembly construction of claim 20 wherein the pattern of grooves on the cathode surface of the solid flexible electrolyte in each of the plurality of adjacent fuel cells is an etched surface.

23. The flexible fuel cell assembly construction of claim 15 wherein the flexible fuel cell assembly construction is a tubular structure.
